(19) United States
(12) Patent Application Publication
(10) Pub. No.: US 2005/0045055 A1
(43) Pub. Date: Mar. 3, 2005

(54) Security printing method

(76) Inventor: Daniel Gelbart, Vancouver (CA)

Correspondence Address: Gavin N. Manning, Esq.;Oyen Wiggs Green & Mutala, Suite 480c The station, 601 west Cordova Street, Vancouver, British Columbia, V6B 1G1, CA

(21) Appl. No.: 10/649,633

(22) Filed: Aug. 28, 2003

(51) Int. Cl. B41F 23/04; B41M 3/14

(52) U.S. Cl. 101/424.2; 283/72

(57) ABSTRACT

A method of adding authentication material during printing by dispensing the authentication material in powder form over the articles being printed before the ink used for the printing is fully cured. The method can be combined with the spray powder step during the printing process.

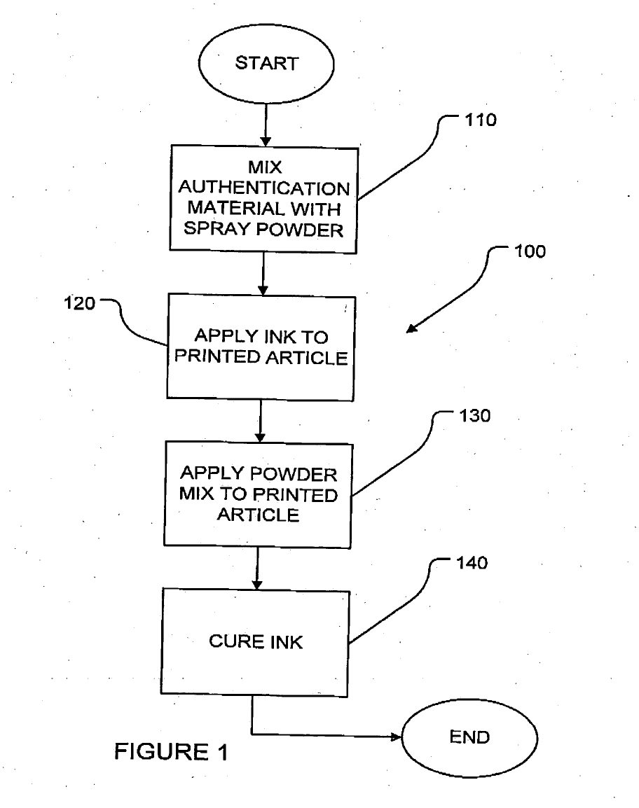

### RELATED APPLICATIONS

No other applications relate

### FIELD OF THE INVENTION

The invention relates to printing, and specifically to security printing of the covert type. This is also known as authentication or as anti-counterfeit technology.

### BACKGROUND OF THE INVENTION

In security printing it is common to add special materials to the ink and paper used in order to be able to detect them later, thus verifying that it is a legitimate copy. The most common materials used for such authentication are fluorescent materials, magnetic materials, specialty tagging materials, biological materials (such as DNA) and others. Since these materials are mixed with the ink (or paper), a rather large amount (from 0.1 volume % to 10 volume %) of authentication material has to be used in order to make detection easy in the presence of all the impurities of the paper and ink. It is also desired that the detection equipment will be portable and inexpensive, therefore large concentrations of material are needed. Mixing the authentication material with the ink has some major disadvantages. Firstly, large amounts of authentication material are needed. Besides being costly, this makes it easy for counterfeiters to analyze printed samples to identify material. Secondly, since there are many types of inks used, inventory management is expensive. Furthermore, when authentication material becomes obsolete a large inventory of ink has to be discarded.

It is the object of the present invention to offer an improved method for adding the authentication material to the printed samples. A further object is to reduce the amount of material needed and decrease its contamination from the ink. Yet a further object is to provide a method compatible with all printing methods such as lithography (both wet and waterless), flexography, gravure, intaglio, ink-jet and xerography. Other advantages of the invention will become clear from the description of the preferred embodiment.

### SUMMARY OF THE INVENTION

The invention uses the spray powder dispenser (also known as anti-offset powder) installed in most presses to dispense an authentication material, which is mixed with the spray powder. The authentication material, in powder form, sticks to the surface of the wet printing ink. As the ink cures the material is permanently bonded to the surface. This allows the authentication material to be employed in the authentication of documents. Because the material is on top of the ink, not mixed with it, a very small amount is required. The method of the present invention is compatible with printing methods such as lithography (both wet and waterless), flexography, gravure, intaglio, ink-jet and xerography.

### BRIEF DESCRIPTION OF THE DRAWINGS

No drawings pertain to the present invention

### DESCRIPTION OF THE PREFERRED EMBODIMENT

In many applications it is desirable to add an authentication material to the ink used in printing in order to detect counterfeit goods. Examples are currencies, stock certificates, boxes of various goods, labels, tickets and many more. Currently this is achieved by mixing an authentication material with at least one of the inks used or adding an overprint using a special ink, typically a fluorescent ink. Such an overprint can be detected under UV light. Since the ink contaminates and obscures the authentication material, large concentrations of authentication material are needed, typically from 0.1 volume % to 10 volume %. This greatly increases the cost of the ink. Overprinting with an invisible ink also significantly increases costs and is easy to duplicate. Because of the very high viscosity of most printing inks, which are more like pastes, mixing has to be done at the factory and special inventory has to be carried by the printer.

Almost all sheet fed presses, as well as some other presses, use a powder dispensing system to prevent the wet ink on one press sheet from sticking to the back of the adjacent sheet. The sticking problem is even more severe with two-sided printing. Such systems are known in the trade as “spray powder” or “anti-offset powder”. These systems are available from all major press manufacturers, such as Heidelberg, MAN-Roland, Komori, KBA, Ryobi, Hamada, AB Dick and others. The presses are normally supplied with the spray powder system installed as part of the press. For presses not equipped with such a system, such as web presses or flexographic presses, a stand-alone spray powder system can be easily added. Such systems are available from vendors such as Grafix (Stuttgart, Germany), Oxy-Dry (www.oxydry.com), Airtech (www.airtech.com) and others. The powders employed in these systems are made of materials such as starch, with particle sizes from about 20 μm to 50 μm, the coarser powders generally used for thicker papers and heavier ink coverage. Powders are available from Oxy-Dry, Varn and many other vendors. Typical coverage is about 30 mg per square meter of printed material. Some of the powder adheres to the ink, which is not fully cured and is permanently trapped by the ink when it cures. The term “cure” should be read to cover all mechanisms of ink becoming solid, such as drying, cross-linking, UV curing etc. As the process of spray powder coating is well-known to practitioners in the field of printing, it will not be further described herein.

The inventors have discovered that mixing an authentication material with the spray powder constitutes an unexpectedly good way of distributing the material for the following reasons:

a. The same powder can be used with all inks and papers, simplifying logistics.

b. Since the powder does not mix with the ink but sticks to the top layer, the authentication material is not contaminated by the ink. This greatly reduces the amount needed for reliable detection. Concentrations as low as one part per million can be detected.

c. Since the concentration of the authentication material is low, it is difficult for counterfeiters to establish the composition of the authentication material via chemical analysis of the ink and paper. Ink and paper contain many impurities at much higher concentrations then the authentication material. At the same time detection is easy with the proper detection unit, as it looks only at the top surface of the ink where concentration of authentication material is higher.

d. Authentication materials have to be periodically changed for increased security.

A spray powder changeover is vastly simpler than an ink changeover as no pre-wash-up is required.

The authentication material can be one or more of the many materials in commercial use at this time. It is desirable to use a particle size matching the spray powder, i.e. from 20 μm to 50 μm but powders as fine as 5 μm can be used. The invention is not limited to any particular type of authentication material. The invention can be used with any of the well-known authentication materials used today, as long as the material is available in powder form.

Some examples of such materials include:

1. Magnetic powders, such as ferrite or Fe₂O₃. The presence of the magnetic powder is detected by magnetizing and passing a pick-up coil over the printed sample.

2. Fluorescent powders. The presence of the fluorescent powder is detected under UV light (“black light”).

3. Biological powders, such as DNA containing powder. These give a very high level of security, due to the difficulty of analyzing the material, at the expense of cost of the detection equipment.

4. Radio frequency absorbing powders. There are detected by a unique absorption signature, typically in the microwave region.

5. Micro tagging powders. These are made by shredding a multi-layered material and microscopically identifying the fine shreds under very high magnification.

By way of example, a mixture containing 1 volume % fluorescent powder, UVXPBR from MaxMax (www.maxmax.com) and 99 volume % spray powder #C-230 from Varn (www.varn.com) was applied to freshly printed sheet using a Grafix Model Alphametrics 200 system, made by Grafix (Stuttgart, germany), and mounted on a Heidelberg SM74 press. The total powder density was about 30 mg per square meter, thus the concentration of the fluorescent authentication material was only 0.3 milligram per square meter. After 24 hours, when the sheets were dry, the presence of the authentication material was detected (in a dark room) with a 375 nm UV flashlight (flashUV2 from www.maxmax.com). In this test, the concentration of the active material was about 100 parts per million relative to the ink.

Even higher sensitivities can be achieved with biological powders, as very sensitive tests exist for their detection.

There have thus been outlined the important features of the invention in order that it may be better understood, and in order that the present contribution to the art may be better appreciated. Those skilled in the art will appreciate that the conception on which this disclosure is based may readily be utilized as a basis for the design of other compositions, elements and methods for carrying out the several purposes of the invention. It is most important, therefore, that this disclosure be regarded as including such equivalent compositions, elements and methods as do not depart from the spirit and scope of the invention.

1. A method for applying an authentication material to a printed article, the method comprising, after applying ink to the article, dispensing the authentication material in powder form over the article before the ink is fully cured, the authentication material comprising at least one of: a fluorescent material; a magnetic material; a DNA containing biological material; and a radio frequency absorbing material.

2. A method according to claim 1 wherein dispensing the authentication material in powder form comprises simultaneously dispensing a spray powder for preventing printed articles from adhering to other objects and wherein dispensing the authentication material and dispensing the spray powder are performed by the same equipment.

3. A method according to claim 2 comprising mixing the authentication material with the spray powder prior to dispensing the authentication material and prior to dispensing the spray powder.

4. A method according to claim 1 wherein the authentication material is light-activated.

5. A method according to claim 1 wherein the authentication material comprises magnetic authentication material.

6. A method according to claim 1 wherein the authentication material comprises biological authentication material.

7. A method for preparing an authenticatable printed article, the method comprising: applying ink to the printed article; and, before the ink applied to the printed article is cured, applying a powder comprising an authentication material atop the ink, the authentication material comprising at least one of: a fluorescent material; a magnetic material; a DNA containing biological material; and a radio frequency absorbing material.

8. A method according to claim 7 comprising allowing the powder to adhere to the uncured ink.

9. A method according to claim 7 wherein the powder comprising the authentication material comprises a mixture of the authentication material with a spray powder for preventing printed articles from adhering to other objects.

10. A method according to claim 9 wherein applying ink to the printed article and applying the powder comprising the authentication material atop the ink are performed in a printing press.

11. A method according to claim 10 wherein applying the powder comprising the authentication material atop the ink is performed by a spray powder system associated with the printing press.

12. A method according to claim 9 wherein the spray powder and the authentication material both comprise particles having dimensions in a range of 20-50 μm.

13. A method according to claim 8 wherein the authentication material comprises at least one of: a magnetic powder detectable by a magnetizable pick up coil; a fluorescent powder detectable via application of ultraviolet light; a biological powder detectable via biological testing; and a radio frequency absorbing powder detectable via a unique radiation absorption signature.

14. A method according to claim 7 comprising curing the ink and thereby bonding the ink to the authentication material.

15. A method according to claim 14 wherein, after curing the ink, a density of the authentication material on a surface of the printed article is about 0.3 mg/m².

16. A method for preparing an authenticatable printed article, the method comprising:
mixing an authentication material with a spray powder for preventing printed articles from adhering to other objects to form a powder mixture;
applying ink to the printed article; and
prior to the ink curing on the printed article, applying the powder mixture to the printed article atop the ink;
wherein the authentication material comprises at least one of: a fluorescent material; a magnetic material; a DNA containing biological material; and a radio frequency absorbing material.

17. A method according to claim 16 comprising allowing the powder mixture to adhere to the uncured ink.

18. A method according to claim 17 wherein applying ink to the printed article and applying the powder mixture to the printed article atop the ink are performed in a printing press.

19. A method according to claim 18 wherein applying the powder mixture to the printed article atop the ink is performed by a spray powder system associated with the printing press.

20. A method according to claim 17 wherein the spray powder and the authentication material both comprise particles having dimensions in a range of 20-50 μm.

21. A method according to claim 17 wherein the authentication material comprises at least one of: a magnetic powder detectable by a magnetizable pick up coil; a fluorescent powder detectable via application of ultraviolet light; a biological powder detectable via biological testing; and a radio frequency absorbing powder detectable via a unique radiation absorption signature.

22. A method according to claim 16 comprising curing the ink and thereby bonding the ink to the authentication material.

23. A method according to claim 22 wherein, after curing the ink, a density of the authentication material on a surface of the printed article is about 0.3 mg/m².

24. A powder mixture for authentication of printed articles, the powder mixture comprising a mixture of an authentication material and a spray powder for preventing printed articles from adhering to other objects wherein the authentication material and the spray powder comprise particles having dimensions in a range of 20-50 μm, wherein the powder mixture is applied over ink that has been printed on the printed articles prior to the ink being cured and wherein the authentication material comprises at least one of: a fluorescent material; a magnetic material; a DNA containing biological material; and a radio frequency absorbing material.

25. A powder mixture according to claim 24 wherein the authentication material comprises at least one of: a magnetic powder detectable by a magnetizable pick up coil; a fluorescent powder detectable via application of ultraviolet light; a biological powder detectable via biological testing; and
a radio frequency absorbing powder detectable via a unique radiation absorption signature.

26. A method according to claim 1 wherein the authentication material comprises a fluorescent material.

27. A method according to claim 1 wherein the authentication material comprises a DNA containing biological material.

28. A method according to claim I wherein the authentication material comprises a radio frequency absorbing material detectable via a unique radiation absorption signature.

29. A method according to claim 7 wherein the authentication material comprises a fluorescent material.

30. A method according to claim 7 wherein the authentication material comprises a DNA containing biological material.

31. A method according to claim 7 wherein the authentication material comprises a radio frequency absorbing material detectable via a unique radiation absorption signature.

32. A method according to claim 7 wherein the authentication material comprises a magnetic authentication material.

33. A method according to claim 16 wherein the authentication material comprises a fluorescent material.

34. A method according to claim 16 wherein the authentication material comprises a DNA containing biological material.

35. A method according to claim 16 wherein the authentication material comprises a radio frequency absorbing material detectable via a unique radiation absorption signature.

36. A method according to claim 16 wherein the authentication material comprises a magnetic authentication material.

37. A powder mixture according to claim 24 wherein the authentication material comprises a fluorescent material.

38. A powder mixture according to claim 24 wherein the authentication material comprises a DNA containing biological material.

39. A powder mixture according to claim 24 wherein the authentication material comprises a radio frequency absorbing material detectable via a unique radiation absorption signature.

40. A powder mixture according to claim 24 wherein the authentication material comprises a magnetic authentication material.
